(19) United States
(12) Patent Application Publication
(10) Pub. No.: US 2017/0085701 A1
(43) Pub. Date: Mar. 23, 2017

(54) METHOD OF SELECTIVE MOBILE DEVICE RESTRICTION AND AUTOMATIC ACTIVITY REPORTING

(71) Applicant: Frankie Thirdkill, Valrico, FL (US)

(72) Inventor: Frankie Thirdkill, Valrico, FL (US)

(21) Appl. No.: 14/857,197

(22) Filed: Sep. 17, 2015

(51) Int. Cl. H04M 1/725

(52) U.S. Cl. CPC H04M 1/72577; H04M 1/72569

(57) ABSTRACT

A software implemented method of selective mobile device restriction for interrupting the features of specified communications applications on a mobile device based on the movement of the mobile device as well as the vehicle in which it is moving. The software implemented method of selective mobile device restriction is implemented through an interruption software application which contains instructions which cause a processor in a mobile device to perform the specified steps which allow it to determine whether a mobile phone on which it is installed is moving in a vehicle and the user of the mobile phone is positioned in the driver's seat of the vehicle, as well as to momentarily disable certain communications features on the mobile device based on its determinations. The momentary interruption continues until the software application determines it is no longer being used by one positioned in the driver's seat of the vehicle.

### BACKGROUND OF THE INVENTION

Field of the Invention

This invention relates generally to use blocking of telecommunications devices and, more particularly, to a software implemented method for selective restriction of mobile device function and automatic reporting of device activity.

Description of the Prior Art

It is well established that distracted driving, commonly defined as driving while engaged in other activities, directly compromises the safety of the driver and any passengers they may have with them, bystanders, and people in nearby vehicles. Distracted driving is often associated with the driver's use of a mobile computer device, such as smartphones and tablets, to place calls, send text messages or emails, or view other content. Thus, there remains a need for a software implemented method of selective mobile device restriction and automatic activity reporting on a mobile computer device (also referred to herein as “mobile device”) which would prevent a driver from using certain features on their mobile device while operating their vehicle. It would be helpful if such a method of selective mobile device restriction prevented distractions like texting while driving by completely disabling the texting and emailing function on the mobile device of a user in the driver's seat of a vehicle in motion. It would be additionally desirable for such a method of selective mobile device restriction to include a driver's seat verification so as to not interfere with the user of mobile devices by passengers.

The Applicant's invention described herein provides for a method of selective mobile device restriction adapted to prevent a driver of a vehicle from using their mobile device while operating the vehicle. The primary steps in Applicant's method of selective mobile device restriction are monitoring vehicle movement, verifying user location in the vehicle, and selectively disabling of software applications. When in operation, the method of selective mobile device restriction enables a complete restriction on the most severe forms of mobile phone distractions from driving on only the mobile device of a user in the driver's seat. As a result, many of the limitations imposed by prior art structures are removed.

### SUMMARY OF THE INVENTION

A software implemented method of selective mobile device restriction for interrupting the features of specified communications applications on a mobile device based on the movement of the mobile device as well as the vehicle in which it is moving. The software implemented method of selective mobile device restriction is implemented through an interruption software application which contains instructions which cause a processor in a mobile device to perform the specified steps which allow it to determine whether a mobile phone on which it is installed is moving in a vehicle and the user of the mobile phone is positioned in the driver's seat of the vehicle, as well as to momentarily disable certain communications features on the mobile device based on its determinations. The momentary interruption continues until the software application determines it is no longer being used by one positioned in the driver's seat of the vehicle.

It is an object of this invention to provide an extension bar for a software implemented method of selective mobile device restriction and automatic activity reporting on a mobile computer device which would prevent a driver from using certain features on their mobile device while operating their vehicle.

It is another object of this invention to provide a method of selective mobile device restriction which prevents distractions like texting while driving by completely disabling the texting and emailing function on the mobile device of a user in the driver's seat of a vehicle in motion.

It is yet another object of this invention to provide a method of selective mobile device restriction which includes a driver's seat verification so as to not interfere with the user of mobile devices by passengers.

These and other objects will be apparent to one of skill in the art.

### BRIEF DESCRIPTION OF THE DRAWINGS

FIG. 1 shows the primary operational steps of a method of selective mobile device restriction in accordance with the present invention.

### DETAILED DESCRIPTION OF THE INVENTION

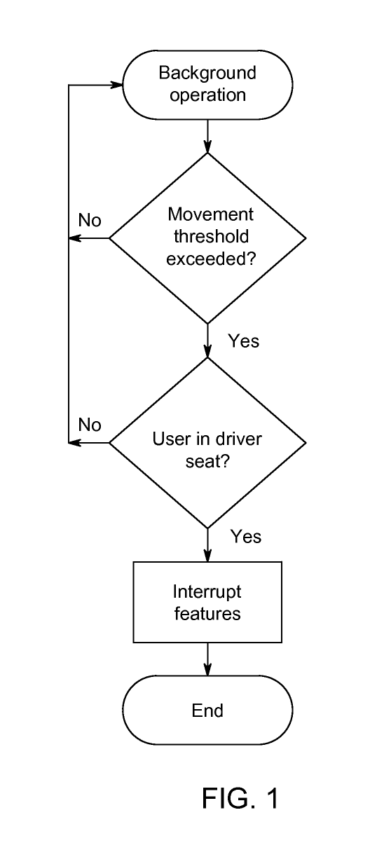

Referring now to the drawings and in particular FIG. 1, a method of selective mobile device restriction is implemented through an interruption software application which contains instructions which cause a processor in a mobile device to perform the steps of monitoring vehicle movement, verifying user location, and selectively disabling of software applications. It is contemplated that in order to enable the operation of the interruption software application, a mobile device on which the interruption software application is loaded must include a camera, a gyroscopic sensor and a satellite position system receiver (such as a GPS receiver), so as to enable the interruption software application to receive data inputs relating to the position of a user of a mobile device in a vehicle and the speed at which the mobile device is traveling.

In operation, the interruption software application is installed on a mobile device such that it is able to monitor outputs from the mobile device's gyroscopic sensor and satellite position system receiver, as well as operate the mobile device's camera. The interruption software application then commences operation in the background of the mobile device's software environment. While operating in the background, the interruption software application continually monitors the output of a satellite positioning system receiver on the mobile device in order to track the speed at which the mobile device is moving. In the preferred embodiment, the interruption software application monitors the output of a GPS receiver to track mobile device movement speed.

The interruption software application includes a preset speed threshold above which the interruption software application commences its determination of the position of its user in a vehicle. In the preferred embodiment, the preset speed threshold can be set at 20 or 25 miles per hour. A user may also select a delayed activation feature which requires the speed threshold to be exceeded for more than 10 continuous seconds (so as to avoid false positives from a user who is running or exercising).

Once the speed threshold has been exceeded, the interruption software application queries the gyroscopic sensor and activates the camera. Using the input from the gyroscopic sensor to determine the spatial orientation of the mobile phone, the interruption software application causes the camera to begin capturing and saving images in front of the camera (which may be facing the back of the mobile device or the back and front of the mobile device, depending on the position of the camera(s) on the mobile device). Using integrated image recognition software, the interruption software application then reviews the images for items which include a dashboard, a gear shifting member, pedals, windows, seatbelts, a center console. If the images contain a dashboard, a gear shifting member, pedals, windows, seatbelts, a center console in a location which, based on the mobile device's spatial orientation, would indicate that the user of the mobile device is in the driver's seat, the interruption software application activates an interruption module which disables the operation of every text messaging application on the mobile device, every dialer application except the emergency dialer application on the mobile device, and every email application on the mobile device. It is appreciated that the interruption module operates essentially as a momentary switch, such that it disables such applications only while it is activated, enabling them to automatically restart once the interruption module is deactivated.

For example, in one embodiment, the interruption software application looks for in the images for gauges in a dashboard, pedals near a floor, a steering wheel on a dashboard, a front windshield and a front passenger window to the driver side of the mobile phone. If more than one of these items is identified through the image recognition software, the interruption software application determines the user is in the driver's seat.

In the preferred embodiment, as long as the movement threshold remains exceeded, the interruption software application will continue monitoring the spatial orientation of the mobile device and capturing images in front of and/or behind the mobile device. If the mobile device is moved to a position in the car where, by positioning of the windows, dash, seatbelts or seat backs, it is determined the user is no longer in the driver's seat, the interruption software application discontinues the interruption module. In one embodiment, the interruption module is discontinued if a seat back is seen in front of the user or if a plurality of gauges in a dashboard, pedals near a floor, a steering wheel on a dashboard, a front windshield and a front passenger window to the driver side of the mobile phone is not able to be recognized in the images.

It is contemplated that the interruption software application, when installed on a mobile device is granted sufficient authority to activate the mobile device's GPS, gyroscopic, and camera functionality in the event either has been disabled.

In one embodiment, the interruption software application includes a reporting module through which gyroscopic and camera outputs, GPS queries, as well as all interruption module activity is transmitted to an administrator. It is contemplated that the administrator may provide such information to local law enforcement.

It is contemplated that the features of the interruption software application are removed from a mobile device on which the interruption software application had been previously installed when removed the interruption software application is uninstalled.

The instant invention has been shown and described herein in what is considered to be the most practical and preferred embodiment. It is recognized, however, that departures may be made therefrom within the scope of the invention and that obvious modifications will occur to a person skilled in the art.

1. A method of selective mobile device restriction for interrupting the features of specified communications applications on a mobile device, comprising the steps of:
providing a mobile device configured to perform steps embodied in software applications, to capture images through at least one integrated camera, to make and receive telephone calls over an electronic network, to send and receive electronic messages over an electronic network, to generate a real time satellite positioning output, and to generate a real time spatial orientation output;
measuring velocity of the mobile device;
confirming, upon the velocity of the mobile device exceeding a preset threshold for a preset duration, whether the mobile device is being held by a user disposed in a vehicle driver seat based on the relative position of the mobile device by capturing at least one image through the at least one integrated camera, processing the at least one image with image recognition software, thereby identifying vehicle related items in the image, and estimating the proximity of the mobile device based on the position of identified items in the at least one image relative to the mobile device and the spatial orientation output at the time the image was captured; and
disabling, upon confirming the mobile device is being held by a user disposed in a vehicle driver seat, the operation of at least one of electronic messaging applications installed on the mobile device and non emergency dialer applications installed on the mobile device.

2. (canceled)

3. The method of selective mobile device restriction of claim 1, wherein processing the at least one image with image recognition software is operative to identify at least one of dashboard gauges in a vehicle, pedals near a vehicle floor, a center console of a vehicle, a steering wheel on a vehicle dashboard, a vehicle windshield, a vehicle window, and a vehicle seat back.

4. The method of selective mobile device restriction of claim 1, wherein the step of measuring utilizes the real time satellite positioning output.

5. The method of selective mobile device restriction of claim 4, wherein preset threshold defines twenty miles an hour.

6. (canceled)

7. The method of selective mobile device restriction of claim 1, wherein preset duration defines ten seconds

8. The method of selective mobile device restriction of claim 1, additionally comprising the step of reporting at least one of velocity measured, images captured, and disabling of applications on the mobile device to a remote device.
